(19) United States
(12) Patent Application Publication
(10) Pub. No.: US 2023/0050373 A1
(43) Pub. Date: Feb. 16, 2023

(54) Electromagnetic System to Modify Weather

(71) Applicant: Olatunbosun Osinaike, Pleasant Prairie, WI (US)

(72) Inventor: Olatunbosun Osinaike, Pleasant Prairie, WI (US)

(21) Appl. No.: 17/866,501

(22) Filed: Jul. 16, 2022

Related U.S. Application Data
(60) Provisional application No. 63/233,331, filed on Aug. 16, 2021.
(60) Provisional application No. 63/237,184, filed on Aug. 26, 2021.

(51) Int. Cl. A01G 15/00; H01F 7/06

(52) U.S. Cl. CPC A01G 15/00; H01F 7/064

(57) ABSTRACT

This invention is a process to modify weather patterns with electromagnetic systems, by creating and/or limiting eddy currents. Oceanwater's salinity increases its electrical conductivity. The conflict between the Earth's electromagnetic field, and the Coriolis Force, is a factor in cyclogenesis. This invented process utilizes artificially induced electromagnetic eddy currents to generate precipitation systems from Eastward Ocean Currents, as well as limits electromagnetic induction caused by the Earth's electromagnetic field, to stall cyclogenesis.

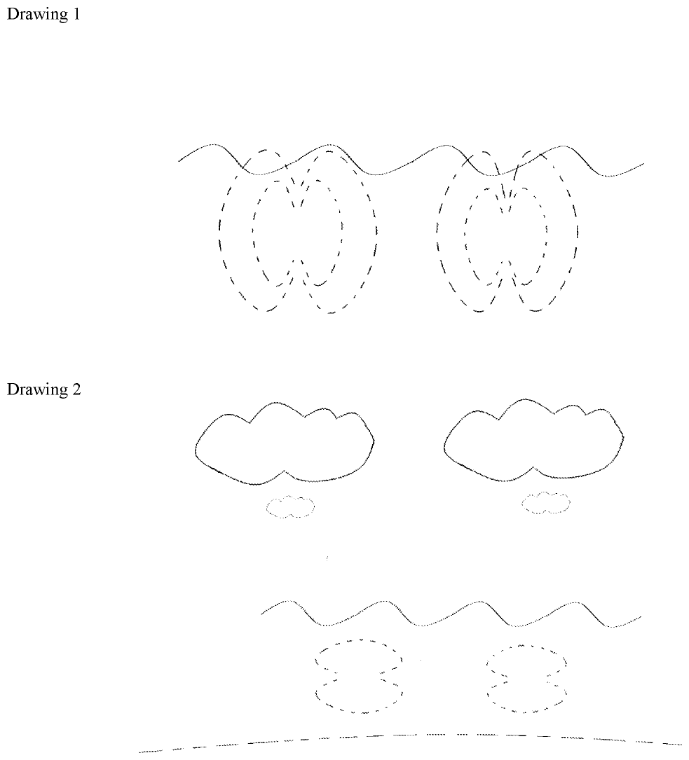

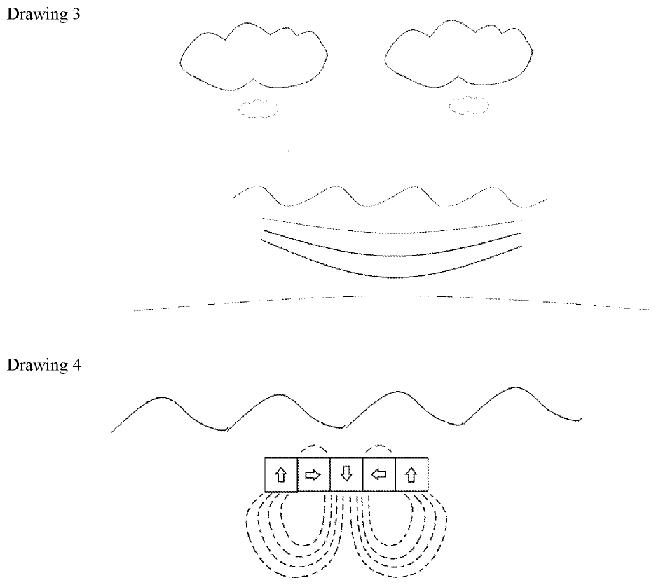

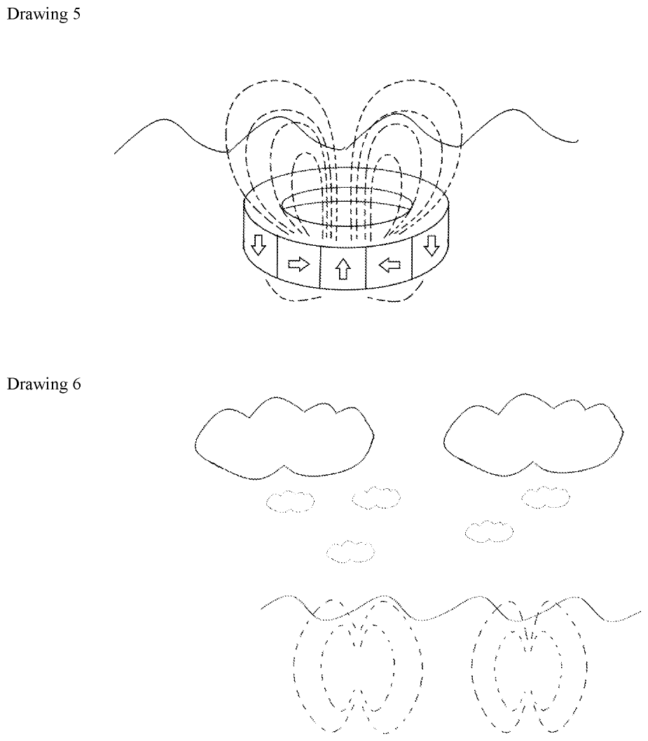

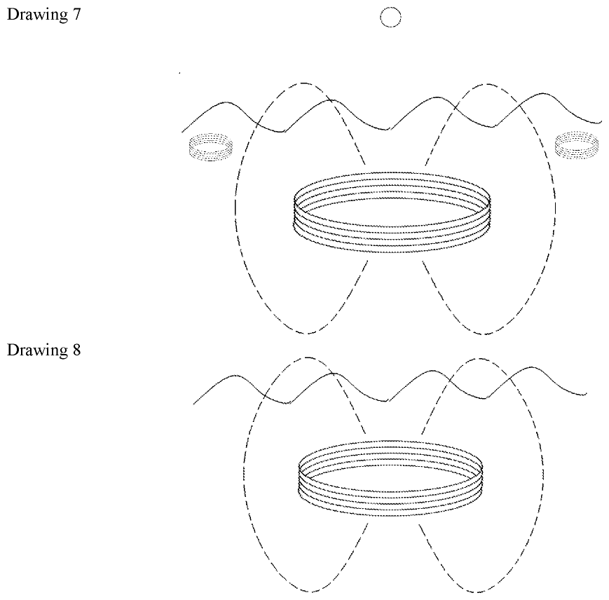

### CROSS REFERENCE TO RELATED APPLICATIONS

This nonprovisional patent application claims the benefit of these provisional patent applications.

63/233,331
63/237,184

### BACKGROUND OF THE INVENTION

This is a utility patent application for the use of artificial electromagnetic fields to modify weather.

### BRIEF SUMMARY OF THE INVENTION

This patent application claims a process which utilizes artificial electromagnetic fields, shields to modify weather patterns. The artificial electromagnetic system may be utilized to stimulate the growth of a precipitation system. The artificial electromagnetic system may also be utilized to stall the growth of a precipitation system. The deployment of the artificial electromagnetic field, shields is focused on utilizing the electromagnetic fields to induce, or limit the induction of, electrical eddy currents in the electrically conductive saltwater, which is an element in the development of precipitation and pressure systems in Earth's weather.

The artificial electromagnetic fields, and changing flux used to evaporate, levitate additional water into precipitation systems, makes the deployment of those artificial electromagnetic fields, within a body of water preferable. This preference also holds for the mitigation, reduction of changing flux, caused by relative motion to Earth's magnetic field. This invention is not limited to the deployment of the artificial electromagnetic fields, shields within a body of water, as the artificial magnetic fields, shields may be deployed on the surface of a body of water, or in an air system, above, near, or not approximate to a body of water.

### BRIEF DESCRIPTION OF THE DRAWINGS

Drawing 1: Drawing 1 illustrates a simple array of artificial electromagnetic fields within a body of water.

Drawing 2: Drawing 2 illustrates an example of how to utilize stable electromagnetic flux, to minimize electromagnetic induction caused by motion relative to Earth's magnetic field. This invention is not limited to artificial electromagnetic fields whose magnetic axis is partially aligned with Earth's magnetic axis.

Drawing 3: Drawing 3 illustrates an additional example of how to minimize electromagnetic induction, by utilizing an electrical conductor, Faraday Cages, though this invention is not limited to open-ended Faraday Cages. An array of layered Faraday Cages may be utilized to minimize electromagnetic induction in Oceanwater currents. The Faraday Cages may be grounded to artificial current sinks, or the Seafloor/Continental Shelf.

Drawing 4: Drawing 4 illustrates how a Halbach Array may be utilized to minimize electromagnetic induction caused by interaction between Earth's electromagnetic field, and Oceanwater. The strong side of the Halbach Array may also face the air-water interface. A Faraday Cage may be applied in the same manner.

Drawing 5: Drawing 5 illustrates how a Halbach Array, or strong sided electromagnetic field can be used to stimulate eddy currents in a body of water, where the Halbach Array is rotated, or tilted, around an axis, put in motion, or amplified. An array of electrical currents may be arranged so that the electromagnetic fields caused by the electric currents combines into a Halbach Array, where the strength of the Array can be changed, as changing flux induces electrical eddy currents. This invention is not limited to strong sided electromagnetic fields or arrays.

Drawing 6: Drawing 6 illustrates an example of how changing flux, strengthening or weakening magnetic field, can induce electrical eddy currents, leading to evaporation and levitation of water vapor, and increasing the precipitation within an air pressure, storm system.

Drawing 7: Drawing 7 illustrates how the invention may be utilized in conjunction with the Moon's gravitational field, during high tide, to further increase evaporation of the Ocean water.

Drawing 8: Drawing 8 illustrates that the artificial electromagnetic field used to limit electromagnetic induction caused by the Earth's electromagnetic field, may be a single magnetic field. This invention may also utilize an array of artificial electromagnetic fields.

### DETAILED DESCRIPTION OF THE INVENTION

This patent application pertains to an electromagnetic system to modify weather. The invented process may utilize artificial electric current, such as alternative current, direct current, artificial electromagnetic field(s), permanent magnets, electromagnets, electrical conductors which change in size, strength or direction, to induce electrical eddy currents in the salt water ocean, and other electrically conductive bodies of water, causing levitation and evaporation, generating a system of precipitation. The process of this patent application may also utilize the electric and magnetic flux found in electromagnetic waves, to generate additional changing flux.

The invented process may also utilize an artificial electromagnetic field(s), permanent magnets, electromagnets, to reduce the induction of electrical eddy currents caused by the change of the Earth's magnetic flux relative to oceanwater, in order to mitigate the emergence of a storm system from Ocean Currents, with a focus on Westward Ocean Currents. The invented process is not limited to the mitigation of storm systems emerging from Westward Ocean Currents. The artificial electromagnetic fields may also utilize stable flux, to minimize cyclogenesis from random change of electromagnetic flux that emerges from Earth's electromagnetic field, regardless of whether the Ocean current is flowing Eastward, Westward.

Ocean water has some properties which allow it to be stimulated by electric currents and electromagnetic fields. Ocean water is salty, full of ions, which grant it its electrical conductivity. Water, in its pure form, is also diamagnetic, meaning it is slightly repelled by magnetic fields. The repulsion caused by induced electrical currents, is ultimately a diamagnetic property.

A change in magnetic flux is able to induce electrical currents and oppositional magnetic field in conductive materials, called eddy currents. This change in flux can be caused by the change in the strength or direction of an external magnetic field, a shift in the placement of the electrically conductive material relative to the external magnetic field's angular/linear flux, or a change in the surface area of the electrically conductive material, exposed to the external magnetic field.

It is important to note that Ocean Eddies and Electrical Eddy Currents are normally distinguished from one another. Ocean Eddies are a term from fluid dynamics, that are similarly named to Electromagnetic Eddy Currents, which is terminology from Electromagnetics.

The Earth's magnetic field is tilted on an axis, slanted away from the Earth's rotational axis. As the Earth rotates, the Earth's magnetic axis rotates around the Earth's rotational axis. This angular divergence is significant, as a change in magnetic flux can be caused by such an angular divergence. If the angular direction of a magnetic field changes with respect to an electrical conductor, that change in magnetic flux can induce electrical eddy currents in the electrical conductor. This tilt of the Earth's magnetic field is sufficient to create electrical eddy currents in some Oceanwater currents, as Oceanwater is salty, and conducts electricity.

The electromagnetic induction caused by Earth's Magnetic Field is more extreme in Ocean currents that travel Westward, as the angular divergence/change is greater due to the Earth's Eastward rotation. In a given 24 Hour Rotation, Westward Ocean Currents experience a sharper precession of the Earth's electromagnetic axis, since they travel in a different direction than the magnetic poles, during the Eastward rotation of the Earth.

The Earth's electromagnetic field is caused by an internal dynamo. The Earth's dynamo is located in the Earth's core. Earth's electromagnetic field rotates East with the rest of the Earth, at all latitudes, because the dynamo that generates Earth's electromagnetic field is close to the Earth's center, and buried within the Earth's crust, mantle, and core. Solid land, and other parts of the Earth's crust, rotate East with the Earth across latitudes.

Oceanwater does not follow the same pattern. Liquids and gases on the Earth's surface are much more subject to the Coriolis Force, and different rotational velocities at given latitudes.

Objects at different latitudes on the Earth experience different rotational speeds during a given rotation of the Earth. The Earth has a wider circumference at the Equator, and thus has a different rotational speed, at the Equator, than it does at the poles. This is due to the fact that objects further away from the poles, move a longer distance during Earth's 24 Hour rotation, giving them a faster speed, which is distance traveled over time. Objects at the poles don't travel as far during Earth's 24 Hour rotation, and have a slower rotational speed in comparison to objects near the Equator.

The Earth's Eastward Rotation causes Air and Water moving towards the Equator to flow West, and Air and Water moving away from the Equator to flow East. Ocean Currents moving toward the Equator are moving Eastward at a slower velocity than the Ocean Water near the Equator, so they drift West. Ocean Currents moving away from the Equator carry their Eastward momentum against slower moving water near the poles. Note, there is a small patch of Ocean, referred to as the Equatorial Countercurrent, which stays on the Equator, and rotates East, with the Earth, due to the fact that the equator is the fastest moving frame of reference.

Ultimately, the spherical shape of the Earth, and its rotational axis, causes a conflict between the Coriolis Force and the Electromagnetic field.

Lenz's Law and Faraday's Law of Electromagnetic Induction support the premise that a change in the angle between a magnetic field and an electrically conductive surface, is a sufficient change in flux to induce electric eddy currents in an electrical conductor, and create a repulsive force between the original electromagnetic field and the electromagnetic field induced in the electric conductor. The oppositional electromagnetic field is created due to resistance to change in the original electromagnetic field.

Westward Oceanwater, forced West by the Coriolis force, experiences much more defined angular change in Earth's magnetic flux, due to the fact that it travels in the opposite direction compared to the Earth's Magnetic Axis. Eastward Oceanwater experiences less change in magnetic flux because it is traveling in the same direction as the Magnetic Axis's rotation.

Electric eddy currents created in a conductive material, have magnetic fields which oppose the change in magnetic flux in the surrounding external magnetic field. These oppositional fields are the result of Lenz's Law, and Faraday's Laws around Electromagnetic Induction.

This is a reason Westward Ocean Currents creates larger, more powerful storms than Eastward Ocean Currents. The repulsive magnetic fields caused by Electromagnetic induction are powerful enough to levitate electrical conductors. The precipitation in strong Westward Storm systems is caused by a combination of evaporation, and levitation.

Interestingly, the South Atlantic Anomaly, a region of reduced electromagnetic strength in the Earth's magnetic field, may be the ultimate reason why the Earth has less Hurricanes in the South Atlantic Region. Although oppositional, electrical eddy electric currents are caused by change in magnetic field strength, the reduction in electromagnetic strength can result in weaker electric eddy currents, compared to strengthening electromagnetic field. The electrical eddy currents induced are stronger when a conductor is moving towards a region with greater magnetic strength.

An alternating current, direct current of changing strength, amplitude, orientation, or change in magnetic flux, can induce oppositional electrical eddy currents in an electrically conductive material. Electromagnetic induction can cause levitation due to the strong repulsion between the induced electromagnetic field(s), and the original electromagnetic field.

This invented process uses the oppositional magnetic fields, and induced electrical eddy currents, to stimulate the evaporation and levitation of water, and create a precipitous weather system. The invention induces electrical eddy currents with artificial alternating currents, artificial direct currents, artificial electromagnetic fields, and/or permanent magnets, which cause a repulsion between the artificial magnetic field, and the electrically conductive Oceanwater, as well as Joule Heating, which further stimulates evaporation of water into a precipitous weather system. The artificial electromagnetic fields which induce the electric eddy currents, may be placed within the ocean water, near the sea surface, or a distance below the surface. The artificial electromagnetic fields may induce electrical eddy currents by changing in strength, orientation, angular flux, direction, or depth in the body of water. The artificial electromagnetic fields may be traditional dipoles, strong-sided magnetic fields, like Halbach arrays, or the circular magnetic flux that revolves around alternating electric current. Solenoids, or looped electrical conductors, electric current, may be utilized to reinforce the strength of the electromagnetic fields, and the induced electrical eddy currents. Electrically conductive solenoids, loops, may be tilted or rotated around an axis to stimulate additional eddy currents in Ocean Saltwater.

Soundwaves, pressure waves may be utilized to help the evaporation of the water coalesce into an air pressure system. The formation of storm systems often thrives in low-pressure air systems, which rotate in different directions by hemisphere. As storm systems often rotate subject to the air-pressure systems interaction with the Coriolis Force, pressure waves may be propagated through a body of water, to help the evaporation of the water, subject to the low-pressure or high-pressure air flow systems, where the pressure waves are propagated in a manner to encourage the formation of an air pressure system, by creating a wind system which rotates around the center of the array.

The invention will help create precipitation systems from Eastward Ocean Currents, which do not experience as drastic changing of electromagnetic flux, when compared to Westward Ocean Currents, since Eastward Ocean Currents travel in the same direction as the Earth's electromagnetic field during the rotation of the Earth. Practitioners of this invention may increase the salinity of the Ocean Saltwater, in order to increase the electrical conductivity of the water being subjected to electromagnetic induction. This invention may also utilize the gravitational field between the Earth and Moon, and operate at high tide, to complement the electromagnetic induction with a gravitational field, but the invention is not limited to times of high tide.

This invented process also may use artificial electromagnetic fields, shields to reduce the change in flux caused by interaction with the Earth's magnetic field. The invented process may utilize artificial electromagnetic fields to stabilize the magnetic flux around potential storm systems' waters, to stall it from becoming excessively precipitous. The artificial electromagnetic field, shield used to mitigate change in flux may be maintained by an artificial direct current that does not change in strength, angular flux, or orientation. The artificial electromagnetic field, shield used to mitigate change in flux may be a strong-sided magnetic field, like a Halbach array, a traditional dipole, or the circular magnetic flux that revolves around a line of direct electric current.

A Faraday Cage is a device utilized to reduce interaction with external electromagnetic fields. A singular Faraday Cage, or array, may be utilized to limit interaction between Ocean, Sea waters and the Earth's electromagnetic field. The Faraday Cage(s) may be enclosed, or open-ended like a ‘booster's bag.’ Faraday Cages are electrical conductors that accumulate electric fields opposite to an external magnetic field, while limiting electromagnetic interaction on their opposite side, or internal side. A Halbach array may be utilized in the same manner as a Faraday Cage, by accumulating electromagnetic field on one side of its assembly, while shielding the other side from electromagnetic stimulus, by reducing the field strength.

Artificial electromagnetic shields utilized to minimize induced eddy currents caused by motion relative to Earth's electromagnetic axis, may be grounded to an external artificial object that acts as a sink for charge, such as a submarine, the Earth's seafloor, or continental shelf, absorbing charge due to low charge density.

The electromagnetic shields may be comprised of independent artificial electromagnetic fields, arrays, which minimize induction of Oceanwater near a region of frequent cyclogenesis, with their own independent electromagnetic field. The electromagnetic shields may also be comprised of electromagnetic conductors, potentially grounded, to submarines, the Earth, or an external object that acts as a current sink. The electromagnetic shields may be layered above and below one another, where each layer is independently grounded with an external current sink. The electromagnetic shields may be grounded at a single point, to prevent ground loops, though this invention isn't solely limited to a single ground point per shielding apparatus. The electromagnetic shields may cover a large area of land, whilst non-moving, or travel adjacent to a potentially developing precipitation system, to minimize changing electromagnetic field under or through an air/water system.

Oceanwater forced to flow West, as a result of the Coriolis Force, experiences a large change in magnetic flux from the Earth's magnetic field, since the magnetic axis rotates East with the Earth. Because the Earth rotates Eastward, the angle between the Earth's magnetic field, which also rotates East, and the electrically conductive Oceanwater near the Equator, moving West, changes at a greater pace, than the angle between the Earth's magnetic field, and the Oceanwater moving East. This is an additional reason why many powerful storm systems arise from Westward Oceanwater Currents.

The artificial electromagnetic fields may be oriented in a manner where the magnetic field axis are aligned with the Earth's electromagnetic field along a given axis. This invention is does not require alignment of electromagnetic axes to mitigate the changing flux affecting Ocean Saltwater.

This invention is not limited to the utilization of artificial electromagnetic fields adjacent to a body of water, as the artificial electromagnetic fields, shields used to stabilize electromagnetic flux, and limit electromagnetic induction, can be maintained through a potential storm, tornado system occurring over land. The electromagnetic field, shield would have minimal deviation, in regards to strength, orientation, angular direction, and would be best maintained by direct current, an array of permanent magnets, or Faraday Shields.

1. Process to generate precipitation from Aquatic Bodies of Water
a. Utilizing artificial electromagnetic fields,
b. Changing in magnetic field strength, orientation, direction, angular flux
c. Inducing electrical currents in Ocean Currents, and oppositional magnetic fields, causing levitation, evaporation of Oceanwater

2. Process to generate precipitation from Eastward Ocean Currents
a. Utilizing artificial electromagnetic fields, array of artificial electromagnetic fields
b. Changing in magnetic field strength, orientation, direction, angular flux
c. Where artificial electromagnetic field(s) placed near or within Eastward Ocean Currents,
d. Inducing electrical currents in Eastward Ocean Currents, and repulsive magnetic fields, causing levitation, evaporation of Oceanwater

3. Process to stall cyclogenesis
a. Utilizing artificial electromagnetic shield(s)
b. Where artificial electromagnetic shield(s) comprised of artificial electromagnetic field, or electromagnetic conductor,
c. And artificial electromagnetic shield placed near or within Westward Ocean Currents,
d. Reducing interaction between Earth's electromagnetic field and the Westward Ocean Saltwater,
e. Minimizing electromagnetic induction caused by Earth's Electromagnetic Field.
